(19) United States
(12) Patent Application Publication
(10) Pub. No.: US 2016/0035514 A1
(43) Pub. Date: Feb. 4, 2016

(54) BUTTON COVER FOR IMPROVING UNIFORMITY OF LIGHTING AND METHOD OF MANUFACTURING THE SAME

(71) Applicant: HYUNDAI MOTOR COMPANY, Seoul (KR)

(72) Inventor: Kyoung Chun Kweon, Seoul (KR)

(21) Appl. No.: 14/569,731

(22) Filed: Dec. 14, 2014

(30) Foreign Application Priority Data
Jul. 30, 2014 (KR) 10-2014-0096990

(51) Int. Cl. H01H 13/04; H01H 13/02

(52) U.S. Cl. CPC H01H 13/04; H01H 13/023; H01H 2219/036; H01H 2219/056; H01H 2219/028

(57) ABSTRACT

The present invention provides a button cover that improves uniformity of lighting, and prevents lighting quality from decreasing while reducing manufacturing costs using a minimal number of light source elements and a method to manufacture the button cover. The button cover includes a transparent resin that operates as a base and an outer surface of the button cover and a colorant applied to the transparent resin. In addition, a convex-concave pattern shape is formed on an inner surface of the button cover and a light source is configured to output light.

### CROSS-REFERENCE TO RELATED APPLICATION

This application claims under 35 U. S. C. §119(a) the benefit of Korean Patent Application No. 10-2014-0096990 filed on Jul. 30, 2014, the entire contents of which are incorporated herein by reference.

### BACKGROUND

1. Technical Field

The present invention relates to a button cover for a button switch of a vehicle, and more particularly to a button cover that improves uniformity of lighting, maintains lighting quality, and reduces manufacturing costs using a minimal number of light source elements.

2. Background Art

In general, a plurality of button switches for manipulating various devices are installed within a vehicle, and the button switches are manipulated to allow a driver to operate functions associated with driving equipment, auxiliary driving equipment, information communication equipment, additional functions for driver safety or convenience, or other various devices mounted within the vehicle. For example, FIG. 1 exemplifies button switches disposed for manipulation of an Audio Video Navigation (AVN) system, various forms of button switches are arranged within a control panel 9 that is mounted on or around a center fascia of a vehicle. An exemplary arrangement of button switches of FIG. 1 allows convenient user operation of multimedia devices, and utilizes spaces, such as an instrument panel and a center fascia, more efficiently.

Since all the button switches for manipulating the devices within a vehicle are used during daytime/nighttime driving, visibility during the day (e.g., when sunlight is present) and night (e.g., when sunlight is no longer present) is important. To provide daytime visibility for a general button switch for a vehicle, a white colorant is added to an outer body of the button switch. In other words, the white colorant is added to the plastic forming of a cover (e.g., cap) of the button switch. Further, lighting is necessary on an inner side of the button cover to provide nighttime visibility. A light emitting diode (LED), which has a substantially high lighting efficiency and a long life span, is widely used as a light source for the button cover.

Using a light source (e.g., LED) allows a driver to view light passing through a button cover by irradiating light from a rear side of the cover. FIG. 2 is an exemplary view showing a daytime state of button switches and a nighttime state of button switches, in which a light source is switched on. FIG. 3 is an exemplary sectional view showing a configuration of a button switch according to the related art. As shown in the drawings, a letter, a picture, or a symbol is displayed without lighting a button during daytime, and a letter is displayed by lighting a button during nighttime.

A letter, a picture, or a symbol is made to appear in a white color as shown in FIG. 2 by painting an outer surface of the cover in a black color and etching a portion of the black paint surface that corresponds to the letter, the picture, or the symbol (e.g., letter display) with a laser. Further, since the color may not be viewed at nighttime, the light irradiated from an LED on the rear side of the button cover transmits the etched portion such that the letter, the picture, or the symbol may be displayed as shown in the lower portion of FIG. 2.

However, when an LED is applied, uniformity of lighting may decrease within a button switch that has a substantial length or is of a substantial size and a discoloring of lighting may appear in the letter, the picture, or the symbol. This may prevent effective lighting of a button when visual convenience and effect are important. Accordingly, a plurality (e.g., two as shown in FIG. 3) of LED elements may be used and the elements operating as a light source may be spaced apart from the button cover, however the sizes of components and manufacturing costs may increase.

In a related art, light is diffused within a button switch by directly adding a guide to the button switch. In another related art, a black based letter appears on an outer surface of a cover (e.g., cap) and a button body on the rear side of the cover is manufactured in a white based color to maximize diffusion of rear lighting. However, the button switch according to the related art requires an increased number of stages for assembly, and the structure of the button switch may be complex and manufacturing costs may increase.

Further, as the shape of the cover for a button switch changes and the sizes of components decrease, a sufficient distance for a guide may be necessary and it may be difficult to uniformly provide lighting based on the change in the shape of the cover. In addition, a plurality of LEDs may be required based on the size of a button. Further, design of components may be restricted, and manufacturing costs may increase as the size of the button increases while the components decrease in size.

### SUMMARY

The present invention provides a button cover for a button switch for a vehicle, which may improve uniformity of lighting, prevent lighting quality from decreasing, and reduce manufacturing costs using a minimal number of light source elements.

The button cover may include a colorant that indicates a letter, a picture, or a symbol is contained within a transparent resin. The transparent resin may be a base and an outer surface of the button cover. The colorant may be painted to cause light emitted from a light source to be transmitted through the letter display, wherein a pattern shape where convex-concaves is repeated on an inner wall surface of the button cover. Light may be input to the inner wall surface of the button cover from the light source.

A light diffuser configured to improve light diffusion and light uniformity may be further disposed within the transparent resin. The content of the light diffuser may be about 1 weight percent (wt %) to about 5 wt % of a resin composite for an entire cover. The content of the light diffuser may be about 1 wt % to about 2 wt % of a resin composite for an entire cover. The light diffuser may be a silicon based light diffuser. In addition, the light diffuser may include spherical particles that have diameters of about 1 micrometer (μm) to about 10 μm. The light diffuser may also include spherical particles that have diameters of about 2 μm to about 3 μm. The content of the colorant may be about 0.5 wt % to about 2 wt % of a resin composite. The colorant may be a white colorant and may be titanium dioxide (TiO₂).

Another aspect of the present invention provides a method for manufacturing a button cover that may include: adding a colorant for a letter, a picture, or a symbol to a transparent resin that operates as a base; injection-molding the transparent resin within a mold, which has convex-concaves at a portion of the mold that corresponds to an inner wall surface of the cover to form a cover shape. The method may also include painting an outer surface of the formed cover; and etching a portion of the outer surface of the cover that corresponds to a letter display that displays the letter, the picture, or the symbol to remove the painted portion.

Further, a light diffuser configured to improve light diffusion and light uniformity may be further contained within the transparent resin. The content of the light diffuser may be about 1 wt % to about 5 wt % of a resin composite for a cover. The content of the light diffuser may be about 1 wt % to about 2 wt % of a resin composite for the cover. A silicon based light diffuser may be used as the light diffuser. About 0.5 wt % to about 2 wt % of the colorant may be added. The colorant may be a white colorant and may be titanium dioxide (TiO₂).

Accordingly, the button cover has the following effects.

1) A separate light diffusing layer may be eliminated by forming a convex-concave structure patterned on an inner wall surface of a button cover that operates as a light receiving part. A button switch of a vehicle may have bonding and durability problems since it is difficult to attach a separate diffusion film or diffusion plate to a cover, application of a light diffusion film is limited, and the button switch is curved or other various shapes. Meanwhile, because a convex-concave structure may be formed within a button cover according to the present invention, a separate diffusion layer may be unnecessary.

Further, optical characteristics (e.g., light uniformity and luminance) may be improved by forming a convex-concave structure on an inner wall surface of a button cover and suggesting an optimum composition of a colorant and a light diffuser.

3) In addition, the number of LEDs used for a button may be reduced due to improvement of uniformity of lighting. Manufacturing costs may also be reduced. A design of a circuit board may be simplified. Freedom in the design of components may be improved.

4) The present invention may be used in many different display devices (e.g., keyboards for a computer or keypads for a portable terminal), which are formed of plastic and to which a colorant is added.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 is an exemplary view exemplifying an arrangement of button switches in a control panel of a vehicle according to the related art;

FIG. 2 is an exemplary view showing a daytime state of button switches of a vehicle and a nighttime state according to the related art;

FIG. 3 is an exemplary sectional view showing a configuration of a button switch according to a related art;

FIG. 4 is an exemplary sectional view schematically showing a configuration of a button switch according to an exemplary embodiment the present invention;

FIG. 5 is an exemplary view showing the size of a light diffuser and a content measurement result in a specimen according to an exemplary embodiment the present invention;

FIG. 6 is an exemplary view showing a change in light uniformity according to addition of a light diffuser according to an exemplary embodiment the present invention;

FIG. 7 is an exemplary view showing a correlation between a white colorant and a light diffuser according to an exemplary embodiment the present invention;

FIG. 8 is an exemplary view showing a measurement result for a specimen diffusion distance and a light uniformity using an open-phase luminometer according to an exemplary embodiment the present invention;

FIG. 9 is an exemplary view showing a measurement result for a light uniformity of a button using an open-phase luminometer according to an exemplary embodiment the present invention; and

FIG. 10 is an exemplary view for comparing uniformities of lights in a button switch according to the related art and a button switch according to an exemplary embodiment the present invention.

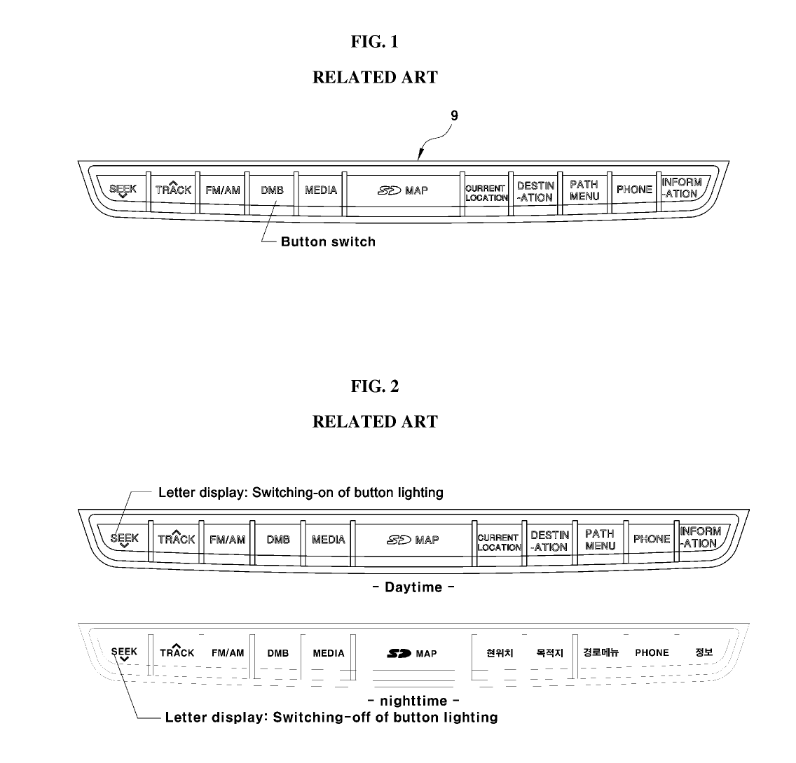

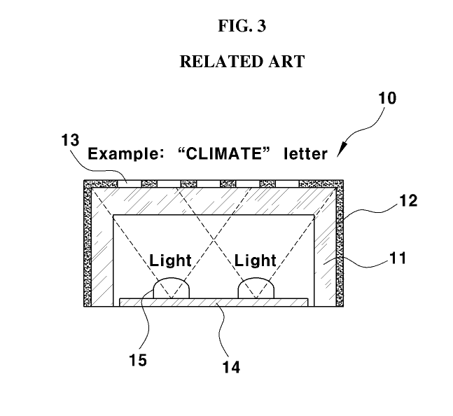

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described in detail with reference to the accompanying drawings so that those skilled in the art to which the present invention pertains can easily carry out the present invention.

The present invention provides a button switch, which may improve uniformity of light, prevent decreasing of quality of a light, and reduce manufacturing costs using a small number of light source elements. The present invention may substantially uniformly diffuse light from a light source (e.g., a light emitting diode (LED)) by adding a colorant and maximize uniformity of a light by forming convex-concaves and patterns having micro structures on an inner wall surface of a button cover. Accordingly, the number of LEDs used and the number of required components may decrease. Since a colorant may be added to a button switch, an effect of a light diffuser may be reduced. Accordingly, the present invention may achieve an optimum composition ratio of additives by which an internal reflection by a colorant may be minimized and a light diffusion may be maximized.

A light diffuser may be added to and compounded with a plastic material for a cover (e.g., a resin composite for a cover) and the plastic material may be injection-molded within a mold, which has convex-concaves on a micro scale, to form a convex-concave shape on an inner wall surface of a cover. Accordingly, a convex-concaves pattern shape configured to diffuse light may be repeatedly formed on an inner wall of the button cover to which light is input from a light source. Further, a colorant for configured to display letters, pictures, and symbols may be displayed through a letter display unit and a light diffuser may be disposed within a transparent resin, which may be a base of the button cover. The unevenness (e.g., light is not uniform) and the discoloring of a light in a button switch for a vehicle may be caused by the strength of light emitted from an LED that travels in a substantially straight direction. A radiation angle of a predetermined value or greater may be used to prevent light unevenness and discoloring

The present invention may add a colorant and a light diffuser to polycarbonate (PC), which is a thermoplastic resin used for a transparent plastic material, for a button cover to minimize internal reflection of light due to the colorant. The colorant may be titanium dioxide (TiO₂) used as a white colorant and the light diffuser may be a silicon based light diffuser in the form of globules.

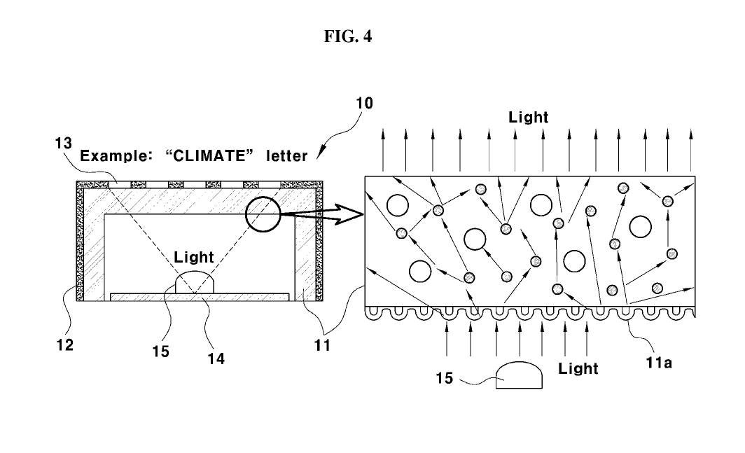

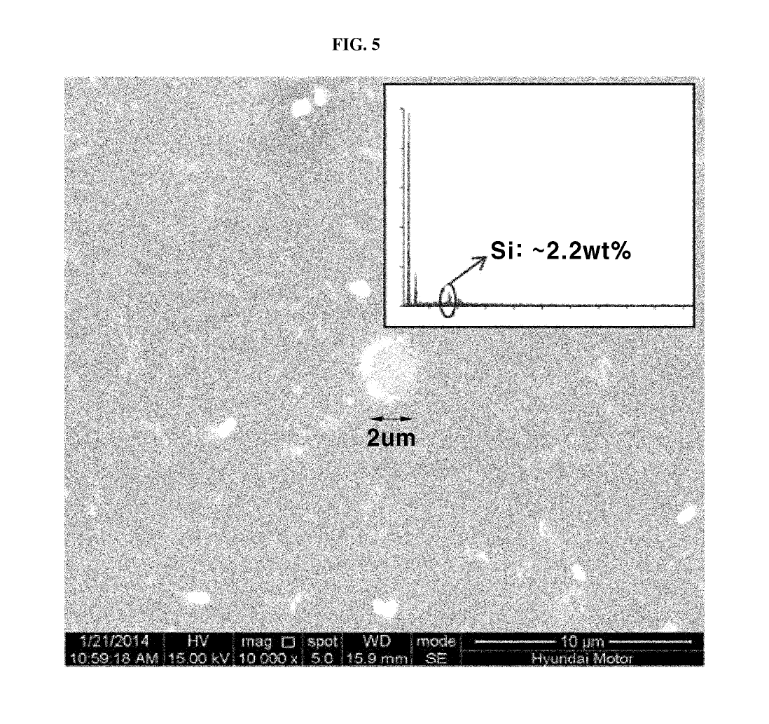

Hereinafter, the button switch according to the present invention will be described in more detail with reference to the accompanying drawings. FIG. 4 is an exemplary sectional view schematically showing the button switch according to an exemplary embodiment of the present invention. The button switch 10 may include a light source element (e.g., light emitting diode (LED)) mounted to a circuit board 14 (e.g., a printed circuit board (PCB)), a button cover 11 configured to be pressed (e.g., engaged) by a user during a manipulation thereof display letters (e.g., letters, pictures, and symbols) through an outer surface thereof, and pass light emitted from the light source element 15 through a letter display unit 13 during a night illumination.

A mounting structure for a cover may include a button switch and a coupling structure of the cover to other components, and a switch contact structure, which may be switched on or off by a pressing operation of the cover, are well known to those skilled in the art, and thus a detailed description thereof will be omitted. Within the button switch, the cover may be manufactured by adding a white colorant and a light diffuser to a transparent plastic material (e.g., a polycarbonate resin) and injection-molding the transparent plastic material. Further, a white letter display unit may be formed by painting a block color on an outer surface of the formed cover 11, and peeling off the black painted portion of the letter display unit 13 that correspond to letters, pictures, and symbols by etching using a laser. Reference numeral 12 of FIG. 4 indicates a painted portion formed by painting an outer surface of the cover.

In the button cover 11 manufactured as described above, light may be refracted on an inner wall surface of the cover and diffused within the interior of the cover. Light emitted from the LED 15 may be refracted through the convex-concave portion 11a of the micro structure (e.g., about 50 micrometers (μm) or less) formed on the inner wall surface of the cover. The light input to the interior of the cover 11 may be refracted once again within the interior of the cover by a spherical silicon based light diffuser that has a refractive index different from that of the cover, and diffusion of the light may be maximized within the interior of the cover.

Since the white colorant may reflect light, the colorant may influence final light characteristics due to internal reflection and scattering based on the addition of the colorant. Further, when a greater amount of white colorant is added, daytime visibility of the button switch 10 may increase, but luminance (e.g., an intensity of light) of a night light may decrease and effective diffusion of light due to a light diffuser may be obstructed. Accordingly, it is necessary to improve characteristics of daytime/night button lighting, such as uniformity and luminance of lighting, while maintaining durability by additionally setting an optimum composition of the light diffuser in a colorant, which is essential for securing daytime visibility.

First, the resin for a cover may be transparent polycarbonate and the colorant added to the resin for a cover may be titanium dioxide, which is a white colorant, and about 0.05 wt % to about 2 wt % of colorant with respect to 100 wt % of a resin composition for a cover may be added to maximize an effect of the silicon based light diffuser while daytime visibility is maintained. In particular, when the colorant is less than the above range (e.g., about 0.05 wt %. to about 2 wt %), daytime visibility may decrease as the letter color may be toned down from white to grey. Further, when the colorant is greater than the above range, luminance of a light may be decreased due to lower light transmittance and an impact strength of the resin may be decreased.

Further, the light diffuser may be a silicon based light diffuser that has spherical particles. The silicon based light diffuser may have a diameter of about 1 micrometer (μm) to about 10 μm. Further, the silicon based light diffuser may have a diameter of about 2 μm to about 3 μm. Acryl based or other materials may have refractive indexes, which are not substantially different from that of polycarbonate, and thus a silicon based light diffuser may be used. Further, when a diameter of the silicon based light diffuser is greater than 10 μm, a convex-concave shape may not be formed on a surface of a specimen. Furthermore, when a diameter of the silicon based light diffuser is less than 10 μm, an effect of the light diffuser may be minimal.

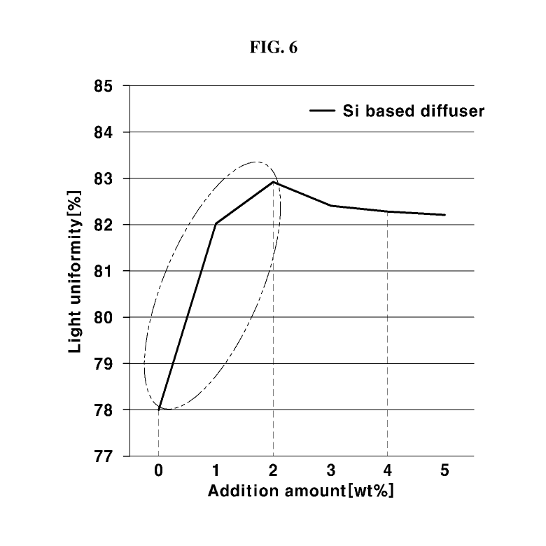

Further, about 1 wt % to about 5 wt % of a light diffuser with respect to 100 wt % of a resin composition for a cover may be added. Improved light uniformity may be shown when up to 5 wt % of the light diffuser is added (see FIG. 6 and Table 1). About 1 wt % to about 2 wt % of a light diffuser may be added in consideration of durability of the cover required when a button switch for a vehicle is applied. In addition, when more than about 2 wt % of the light diffuser is added, the durability of the cover may decrease.

The light uniformity of the specimen was measured using scanning microscope equipment after the addition amount of the silicon based light diffuser is increased from to about 1 wt % to about 5 wt %. In the measurement result, as shown in FIG. 6, as the amount of the silicon added based light diffuser increases up to about 2 wt %, the light uniformity may also rapidly increase. Accordingly, light input into the interior of the button cover may be refracted due to a difference between a refractive index (e.g., n=1.59) of the polycarbonate and a refractive index (e.g., n=1.4) of the silicon based light diffuser.

Further, when the amount of the silicon added based light diffuser begins to exceed 2 wt %, the light uniformity thereof may decrease to a degree, and the light uniformity may remain substantially constant even when a larger amount of the silicon based light diffuser is added. Accordingly, light may not be diffused by sufficient refraction thereof when the contents of the colorant and the light diffuser exceed about 4% of the entire weight. In addition, since impurities are contained within polycarbonate, impact resistance and tensile strength may decrease when the amount of the light diffuser exceeds about 2 wt %. Accordingly, less than about 2 wt % of a silicon added material may be used to produce a button that has excellent daytime and nighttime visibility while ensuring the durability of the button.

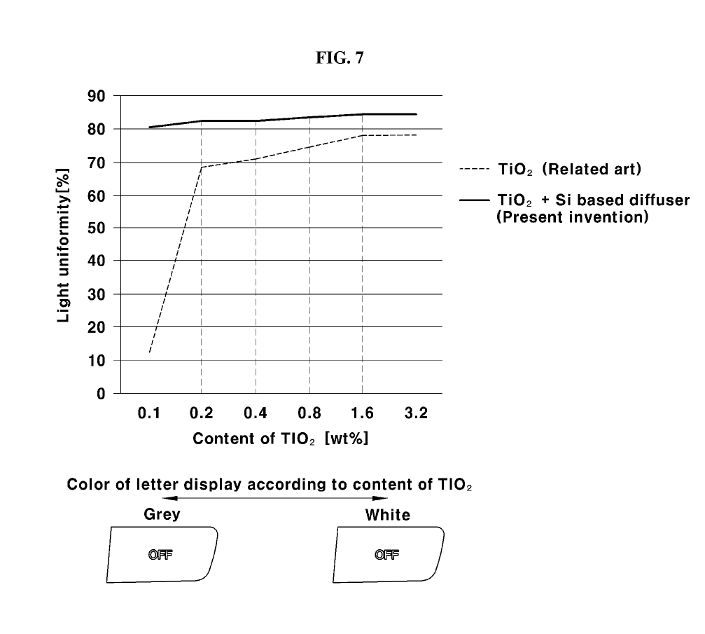

A correlation between the white colorant (e.g., TiO₂) and the light diffuser may be as follows. First, as shown in FIG. 7, light uniformity may increase as the amount of the white colorant increases when the white colorant is added to the resin for a cover. In addition, light uniformity may be substantially low when a finite amount (e.g., about 0.1 wt %) of the white colorant is used. Further, light uniformity may rapidly increase at about 0.2 wt %, which means that the white colorant may cause internal scattering via reflection of a part of light. When the white colorant is added, the change in light uniformity may be minimal even when the addition amount of the white colorant further increases and the light diffusion is slightly affected.

Meanwhile, when about 0.8 wt % of the light diffuser is additionally added to the white colorant, light uniformity may exceed 80% even when the light diffuser is added and the content of the colorant is about 0.1 wt %. Accordingly, light may be effectively diffused within the interior of the resin due to a difference between refractive indexes of the light diffuser and the basic button cover material (e.g., PC), and light uniformity does not change significantly even when the content of the colorant increases.

The light diffuser may be effective for the improvement of light uniformity of a button cover when the content of the white colorant is substantially low, when light uniformity decreases as the content of the white colorant increases. The white colorant may be a material that allows the letter display of the button switch to appear white in the daytime. Further, the color of the letter display may be adjusted from a dark grey color to a dense white color by adjustment of the colorant (e.g., TiO₂). Accordingly, when the color of the letter display is substantially white within the button switch, light uniformity may more effectively increase as the addition amount of the light diffuser increases up to about 2 wt %. When the color of the letter display in a color is substantially grey, light uniformity may effectively increase even when the addition amount of the light diffuser is minimal.

Table 1 shows an exemplary result obtained by measuring light uniformity and transmittance after manufacturing specimens while varying the contents of a light diffuser and a colorant. Comparative Example 1 corresponds to a specimen in which the content of a white colorant is a conventional content applied to a general button cover of the related art. Comparative Example 2 corresponds to a specimen in which the content of the white colorant is set to about 1.7 wt % and a diffuser is not used. Comparative Examples 3 to 5 correspond to specimens in which the content of the white colorant is set to about 1.7 wt % and the contents of the silicon based diffuser are set to 1, 2, 3, 4, and 5 wt %.

The measurement result of Table 1 shows that the optimum contents of additives which satisfy light uniformity and transmittance at the same time may be about 2 wt % of a light diffuser and about 1.7 wt % of a colorant (e.g., Specimen 4).

TABLE 1

| | Comparative | | | | | | |
|---|---|---|---|---|---|---|---|
| | Example 1 | Comparative | Comparative | Comparative | Comparative | Comparative | Comparative |
| Classification | (Coventional) | Example 2 | Example 1 | Example 2 | Example 3 | Example 4 | Example 5 |
| Content of | 0 | 0 | 1 | 2 | 3 | 4 | 5 |
| Diffuser (wt %) | | | | | | | |
| Content of | 2 | 1.7 | 1.7 | 1.7 | 1.7 | 1.7 | 1.7 |
| Colorant (wt %) | | | | | | | |
| Light | 78.03 | 78.11 | 82.04 | 83.08 | 82.4 | 82.27 | 82.19 |
| Uniformity (%) | | | | | | | |
| Transmittance | 1.2 | 6.055 | 6.038 | 5.599 | 5.171 | 5.252 | 5.088 |
| (%) | | | | | | | |

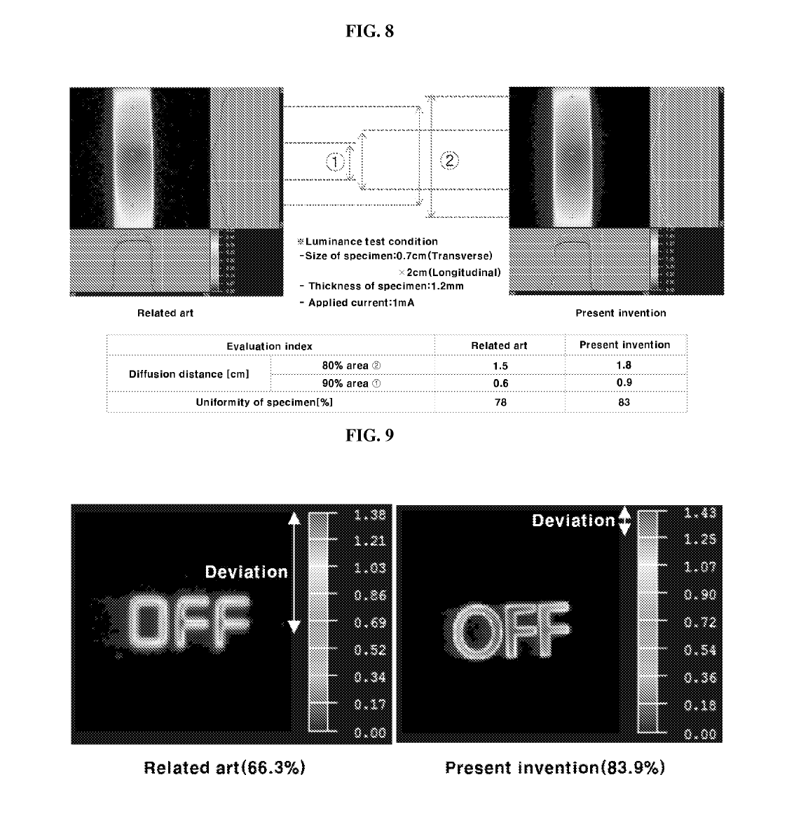

Further, an exemplary specimen containing about 1.7 wt % of titanium dioxide (TiO₂) as a white colorant and about 2 wt % of a silicon based light diffuser was in an evaluation of illumination on the specimen, and the exemplary measurement result will be described with reference to FIG. 8.

A diffusion distance and a light uniformity of illumination within an exemplary specimen were measured using an open-phase luminometer. A conventional specimen (e.g., only TiO₂ is added to the cover resin) and the an exemplary specimen (e.g., a TiO₂ colorant and an Si based light diffuser are added to the cover resin) used had a width of about 0.7 cm, and a height of about 2 mm and a thickness of about 1.2 mm. The diffusion distance of light was classified into an about 80% area (1) and an about 90% area (2) when the maximum luminance is 100%, through which the light uniformities of the button illumination could be compared.

The luminance of light that corresponds to an intensity of light may be expressed by colors and a stronger red color may mean that luminance is increased, and FIG. 8, shows that luminance of an LED may decrease as distance from a substantially central portion of the specimen increases. A diffusion distance may be calculated based on a degree by which luminance decreases from the center, which may be a maximum luminance point. The diffusion distance that corresponds to an area when the luminance is about 80% of the maximum luminance of lighting in the specimen according to the related art may be about 1.8 cm in the exemplary specimen, which increased by about 0.3 cm from the conventional specimen. Likewise, the diffusion distance that corresponds to an area when the luminance is about 90% of the maximum luminance may also increase by 0.3 cm, which may be a size sufficient to add at least one letter to a button. Further, in the exemplary specimen of the present invention, light uniformity was about 83%, and increased by about 5% relative to about 78% of the conventional specimen according to the related art.

Light uniformity was evaluated by manufacturing a button switch based on the result, and referring to FIG. 9, the color may appear redder (e.g., more red) as luminance increases. When luminance is substantially high at the substantial center and light uniformity is 66.3% due to a severe deviation at the outer edge within the button lighting according to the related art, light uniformity may be a substantially high value (e.g., about 83.9%) when testing the present invention.

Meanwhile, a pattern shape in which convex-concaves are repeated may be formed on an inner wall surface of a cover for a button switch in the present invention. In addition, a colorant and a light diffuser may be added to the cover resin and compounded. Further, the resin may be injection-molded in a mold that has convex-concaves at a portion of the mold that corresponds to an inner wall surface of the cover. Convex-concaves of a substantially micro scale as shown in FIG. 4 may be formed on the inner wall surface of the formed cover. When the convex-concave structure is formed on the inner wall surface of the cover, light uniformity of the button switch may be improved. Further, a separate light diffusing layer that may include a diffusion film or a diffusion plate may be eliminated from a cover of a button switch.

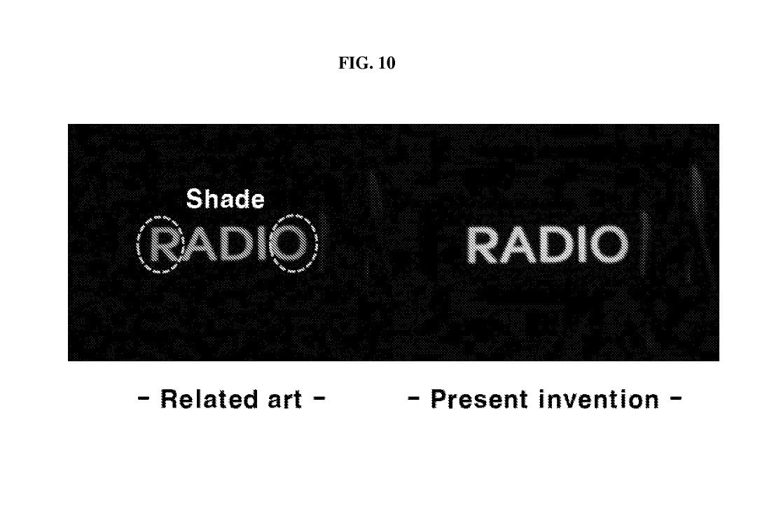

Table 2 and FIG. 10 show an exemplary result obtained by manufacturing an exemplary button switch and evaluating lighting visibility at nighttime in a dark room. One LED was used for each of the button switches in the comparative examples and the exemplary embodiment. The button switch of Comparative Example 3 corresponds to a button cover manufactured by adding about 2 wt % of a white colorant as in Comparative Example 1 of Table 1. A sixth exemplary embodiment, as shown in Table 2, may be manufactured by adding about 2 wt % of a silicon based diffuser and about 1.7 wt % of a white colorant without forming a convex-concave structure of the inner surface of the button switch. A seventh exemplary embodiment, as shown in Table 2, of the present invention may be manufactured using about 1.7 wt % of a white colorant without using a diffuser and forming a convex-concave structure on an inner wall surface of the button cover. An eighth exemplary embodiment of the present invention may be manufactured using about 2 wt % of a silicon based diffuser and about 1.7 wt % of a white colorant and forming a convexo-concave structure on an inner wall surface of the button cover.

TABLE 2

| | | | | Eighth |
|---|---|---|---|---|
| | | | Seventh | Exemplary |
| | | | Exemplary | Embodiment |
| | | Sixth | Embodiment | (Diffuser |
| | Comparative | Exemplary | (Convex- | and Convex- |
| | Example 3 | Embodiment | concave | Concave |
| | (Related | (Diffuser | Structure | Structure |
| Classification | Art) | Applied) | Applied) | Applied) |
| Light | 66.3 | 83.9 | 80.7 | 84.2 |
| Uniformity (%) | | | | |
| Average | 0.65 | 1.2 | 1.1 | 1.18 |
| Luminance | | | | |
| (cd/m²) | | | | |

When a diffuser or a convex-concave structure is used as in Table 2, light uniformity may increase. Light uniformity may be maximized when both the diffuser and the convex-concave structure are used.

Further, the left side of FIG. 10 shows an exemplary button lighting of Comparative Example 3 within a dark room according to the related art and the right side of FIG. 10 shows an exemplary button lighting according to an exemplary embodiment of the present invention. Further, differences between light uniformities and luminance of the button switch according to the related art and the button switch according to the present invention are shown through a nighttime lighting test in a dark room. Referring to FIG. 10, a distinct shade may exist at an outer edge portion (e.g., portions ‘R’ and ‘O’) of the button switch according to related art, but light uniformity may improve in the button switch according to the present invention.

When both a diffuser and a convex-concave structure are applied in the present invention, a change in light uniformity may rarely change. Further, light uniformity may be substantially maintained regardless of the shape or type of a letter, a picture, or a symbol of the button switch according to the present invention.

Although the exemplary embodiments of the present invention have been described in detail, the scope of the present invention is not limited thereto but various modifications and improvements made by those skilled in the art using the basic concept of the present invention defined in the claims also fall within the scope of the present invention.

What is claimed is:

1. A button cover for improving light uniformity, comprising:
a transparent resin that operates as a base and an outer surface of the button cover;
a colorant applied to the transparent resin;
a convex-concave pattern shape formed repeatedly on an inner wall surface of the button cover; and
a light source configured to output light to the inner wall surface of the button cover.

2. The button cover of claim 1, further comprising a light diffuser configured to improve light diffusion and light uniformity within the transparent resin.

3. The button cover of claim 2, wherein the light diffuser is about 1 weight percent (wt %) to about 5 wt % of the button cover.

4. The button cover of claim 2, wherein the light diffuser is about 1 wt % to about 2 wt % of the button cover.

5. The button cover claim 4, wherein the light diffuser is a silicon based light diffuser.

6. The button cover of claim 4, wherein the light diffuser includes spherical particles that have a diameter of about 1 micrometer (μm) to about 10 μm.

7. The button cover of claim 4, wherein the light diffuser includes spherical particles that have a diameter of about 2 μm to about 3 μm.

8. The button cover of claim 4, wherein the colorant is about 0.5 wt % to about 2 wt % of the button cover.

9. The button cover of claim 8, wherein the colorant is titanium dioxide (TiO₂).

10. A method of manufacturing a button cover, comprising:
adding a colorant for that indicates a letter, a picture, or a symbol to a transparent resin;
injection-molding the transparent resin within a mold to form a cover shape that has a pattern shape of convex-concaves for light diffusion repeatedly formed on the inner wall surface of the cover;
painting an outer surface of the formed cover; and
etching a portion of the outer surface of the cover that corresponds to a letter display that displays the letter, the picture, or the symbol to remove the painted portion.

11. The method of claim 10, further comprising adding a light diffuser that improves light diffusion and light uniformity to the transparent resin.

12. The method of claim 11, wherein the light diffuser is about 1 weight percent (wt %) to about 5 wt % of the button cover.

13. The method of claim 11, wherein the light diffuser is about 1 wt % to about 2 wt % of the button cover.

14. The method of claim 13, wherein the light diffuser is a silicon based light diffuser.

15. The method of claim 13, wherein about 0.5 wt % to about 2 wt % of the colorant is added.

16. The method of claim 15, wherein the colorant is titanium dioxide (TiO₂).
